(19) United States
(12) Patent Application Publication
(10) Pub. No.: US 2009/0188936 A1
(43) Pub. Date: Jul. 30, 2009

(54) Chip Dispensing Container

(76) Inventor: Thomas Marando, Wilmington, DE (US)

Correspondence Address: JEFFREY C. LEW, 2205 SILVERSIDE ROAD, WILMINGTON, DE, 19810, US

(21) Appl. No.: 12/022,805

(22) Filed: Jan. 30, 2008

(51) Int. Cl. B65G 59/00; B65D 8/00; G07F 11/00; B65D 25/28

(52) U.S. Cl. 221/279; 220/669; 220/752; 222/1

(57) ABSTRACT

An improved chip dispensing container for distributing, storing and serving tube-stacked chip articles includes a rigid tubular case, a sling inside the case, a, handle outside the case and cables connecting the sling to the handle. The cables pass in contact with bearings near the rim of the container on their courses between sling and handle such that moving the handle downward from an initial position near the rim, pulls on the cables and thereby hoists the sling upward from an initial position near the bottom of the container. Conversely the sling is lowered by moving the handle upward. The stack of chips resting on the sling can thus be raised or lowered by manipulating the handle to controllably access all of the chips in a tube-stacked chip array. The container can be used to package, store and serve stackable, chip shaped products such as potato crisps, cookies, candy disks and wafers

### FIELD OF THE INVENTION

This invention relates to a dispensing container for a stack of discrete, wafer-like articles. More specifically it relates to a rigid tubular container primarily useful for storing a stack of thin, delicate food items such as potato chips which container has an externally operable sling to raise the stack of items to render the items more easily accessible.

### BACKGROUND OF THE INVENTION

For many years potato chips have been a very popular and commercially significant snack food. The chips are thin potato slices that are fried or baked to crispy flakes. Due to the variability of the potato shapes and the cooking processes, traditional potato chips are usually significantly different from each other in shape and have irregular three-dimensional conformations.

A modern conventional package for potato chips is a flexible, foil or film bag. The chips are deposited randomly into the bag which is then sealed with a vapor-resistant closure to retain freshness and food quality cleanliness of the packaged product. Because the chips are irregularly shaped, they do not pack closely to each other and thus the filled bags occupy a large volume of space per unit weight of chips. The thin and crispy chips are fragile and are therefore subject to crumbling with very little externally applied force. Thin, flexible-walled bags offer negligible protection from shipping and handling activity during product distribution. Consequently, a substantial amount of broken chips is often found in the bagged product.

Another well known method of packing chips utilizes metal cans that have slip-on, friction-fit lids. These have traditionally been used for packaging large volumes of chips. While these packages provide greater protection against chip breakage from rough handling during distribution, metal cans are large, heavy, use excessive amount of expensive metal package material, expensive to fabricate, and are not economical for distribution of small quantities of chips.

U.S. Pat. No. 3,498,798 (Baur et al.) discloses an improved system for packaging potato chip and similar products that basically has two major facets. Firstly, Baur provides chips that are substantially uniform in size and shape. This feature permits the individual chips to closely pack with each other, preferably in a stacked array and thereby increases the bulk density of the packaged product. Preference is shown for a non-planar chip curved in two orthogonal directions, especially saddle-shaped, to provide rigidity of the chip in many directions and to prevent chips from slipping off the stack. Secondly, Baur packages a stack of the close-packed chips in a light weight, non-metallic rigid tubular container. The cross section of the container conforms closely to the dimensions of the stacked chips which conserves space and materials. Baur illustrates a cylindrical tubular package. The rigidity of the package protects the chips from physical damage. The entire disclosure of this and all US patents identified in this application are hereby incorporated by reference herein.

The improved product disclosed by Baur is currently commercially available under the name Pringles® (Proctor and Gamble), and perhaps other brands (collectively hereinafter, “tube-stacked chip” product). These have achieved broad consumer acceptance and apparent marketing success. Although the tube-stacked chip product substantially solved many of the problems faced by the randomly packaged chip predecessors, it still has some drawbacks.

A troublesome aspect is poor access to the lower chips in the stack. After the first few chips are pulled from the container, it is usually not possible to reach into the tube by hand to extract additional chips that are farther from the top. The cross section of the tubes of commercial tube-stacked chips is too narrow for the typical adult hand to fit inside and there is little space between the side of the stack and the interior wall of the tube to grasp chips for retrieval.

The normal method of withdrawing chips advised by Baur is to pour the chips out. Unless done with extreme care, pouring the chips is likely to be wasteful and messy. Tilting the container too much can cause many chips to slide out too quickly. Then the user must hold the excess chips in hand or in a secondary container such as a plate, bowl or the like, or replace them in the container. Not infrequently some of the quickly pouring chips are spilled and must be discarded. Handling the excess chips is unsanitary and the additional chip movement promotes breakage and increased crumbling.

Also, the chips are fragile entities. Despite improved structural strength and slippage resistance of the chips attributable to the curved shape and rigidity of the container, some chip breakage and crumbling often does occur. The small pieces and crumbs of broken chips tend to settle in the bottom of the container. When the container is tilted to pour the chips out, these pieces and crumbs can fall out haphazardly and messily. Although one might use a secondary container, it may not be available. This might be the situation, for example, at a spectator event, a picnic, or similar casual entertainment venue at which the user eats the chips directly out of the container.

An improvement to the tube-stacked chip container that enables all of the chips in the package to dispense in a controlled fashion is desired. It is wanted to have a dispenser for tube-stacked chips that avoids the need to tilt the container to pour out the chips. An improved tube-stacked chip dispensing container that reduces the spilling of broken pieces and crumbs is desirable. There is also a desire for a dispensing container that reduces the need to use a secondary container to catch the chips, broken pieces and crumbs when pouring chips from the dispensing container.

### SUMMARY OF THE INVENTION

There is now presented an improved chip dispensing container for distributing, storing and serving tube-stacked chip articles that includes a rigid tubular case, a sling inside the case, a handle outside the case and cables connecting the sling to the handle. The cables pass in contact with bearings near the rim of the container on their courses between sling and handle such that moving the handle downward from an initial position near the rim, pulls on the cables and thereby hoists the sling upward from an initial position near the bottom of the container. Conversely the sling is lowered by moving the handle upward. The stack of chips resting on the sling can thus be raised or lowered by manipulating the handle to controllably access all of the chips in a tube-stacked chip array.

Accordingly, the present invention provides chip dispensing container for a stack of articles comprising (a) a case having a tubular body defining an axis, an external body profile, and a rim at one axial end of the case defining the periphery of an opening of size effective to receive the stack, (b) a sling inside the case adapted move along the axis, (c) a handle circumscribing the body profile and adapted to slide along the axis outside of the case, (d) a plurality of cables oriented parallel to the axis and positioned apart from each other along the opening, and (e) a bearing for each cable positioned proximate to the rim, in which each cable is affixed at one cable end to the sling, extends axially inside the case from the sling to a bearing, contacts the bearing, extends axially outside the case from the bearing to the handle, and is affixed at the other cable end to the handle.

There is also provided a method of packaging chip-shaped articles comprising the steps of (I) providing a stack of a plurality of substantially identically chip-shaped articles, (II) providing a chip dispensing container comprising (a) a case having a tubular body defining an axis, an external body profile, and a rim at one axial end of the case defining the periphery of an opening of size effective to receive the stack, (b) a sling inside the case adapted move along the axis, (c) a handle circumscribing the body profile and adapted to slide along the axis outside of the case, (d) a plurality of cables oriented parallel to the axis and positioned apart from each other along the opening, and (e) a bearing for each cable positioned proximate to the rim, in which each cable is affixed at one cable end to the sling, extends axially inside the case from the sling to a bearing, contacts the bearing, extends axially outside the case from the bearing to the handle, and is affixed at the other cable end to the handle, and (III) placing the stack into the container such that the chip-shaped articles remain in a stacked conformation with one article at a foot of the stack being in contact with the sling, another article at a head of the stack being proximate to the rim and the stack aligned parallel to the axis.

There is further provided a method of dispensing chip-shaped articles comprising the steps of (I) providing a chip dispensing container containing a stack of a plurality of substantially identically chip-shaped articles, in which the container comprises (a) a case having a tubular body defining an axis, an external body profile, and a rim at one axial end of the case defining the periphery of an opening of size effective to receive the stack, (b) a sling inside the case adapted move along the axis, (c) a handle circumscribing the body profile and adapted to slide along the axis outside of the case, (d) a plurality of cables oriented parallel to the axis and positioned apart from each other along the opening, and (e) a bearing for each cable positioned proximate to the rim in which each cable is affixed at one cable end to the sling, extends axially inside the case from the sling to a bearing, contacts the bearing, extends axially outside the case from the bearing to the handle, and is affixed at the other cable end to the handle, and in which the stack is positioned in the container such that the chip-shaped articles remain in a stacked conformation with one article at a foot of the stack being in contact with the sling, another article at a head of the stack being proximate to the rim and the stack aligned parallel to the axis, (II) maintaining the container in vertical orientation such that the opening faces upward, (III) moving the handle downward to elevate the stack effectively to expose an article at the head of the stack above the rim, and (IV) removing the article at the head of the stack.

### BRIEF DESCRIPTION OF THE DRAWINGS

FIG. 1 is a partial section perspective view of an embodiment of the chip dispensing container according to this invention.

FIG. 2 is a different perspective view of the embodiment of the chip dispenser of FIG. 1.

FIG. 3 is a perspective view of a typical chip in accord with the prior art which is suitable for packaging in the chip dispensing container of this invention.

FIG. 4 is a perspective view of an embodiment of a cover for a chip dispensing container according to this invention.

FIG. 5 is a perspective view of the cover of FIG. 4 showing a central panel removed.

FIG. 6 is a perspective view of a portion of an embodiment of a chip dispensing container according to this invention showing placement of a handle formed from the cover of FIGS. 4 and 5.

FIG. 7 is a schematic elevation view of a conventional commercial package of stacked chip product alongside a novel reusable chip dispensing container according to this invention.

FIG. 8 is a schematic elevation view of the novel reusable chip dispensing container of FIG. 7 in position preliminary to transfer of the stacked chip product into the novel container according to this invention.

FIG. 9 is a schematic elevation view of the novel reusable chip dispensing container of FIG. 8 in a later stage of transfer of the stacked chip product into the novel container.

FIG. 10 is a schematic elevation view of the novel reusable dispensing container of FIG. 9 in a later stage of transfer of the stacked chip product into the novel container.

FIG. 11 is a schematic elevation view of the novel reusable dispensing container of FIG. 10 in a later stage of transfer of the stacked chip product into the novel container.

FIG. 12 is a schematic elevation view of the novel reusable dispensing container of FIG. 11 in a later stage of transfer of the stacked chip product into the novel container.

FIG. 13 is a schematic elevation view of the novel reusable dispensing container of FIG. 12 at a final stage of transfer of the stacked chip product into the novel container.

FIG. 14 is a schematic elevation view of the novel reusable dispensing container of FIG. 13 illustrating the stack of chip product partially elevated within the container.

### DETAILED DESCRIPTION OF THE INVENTION

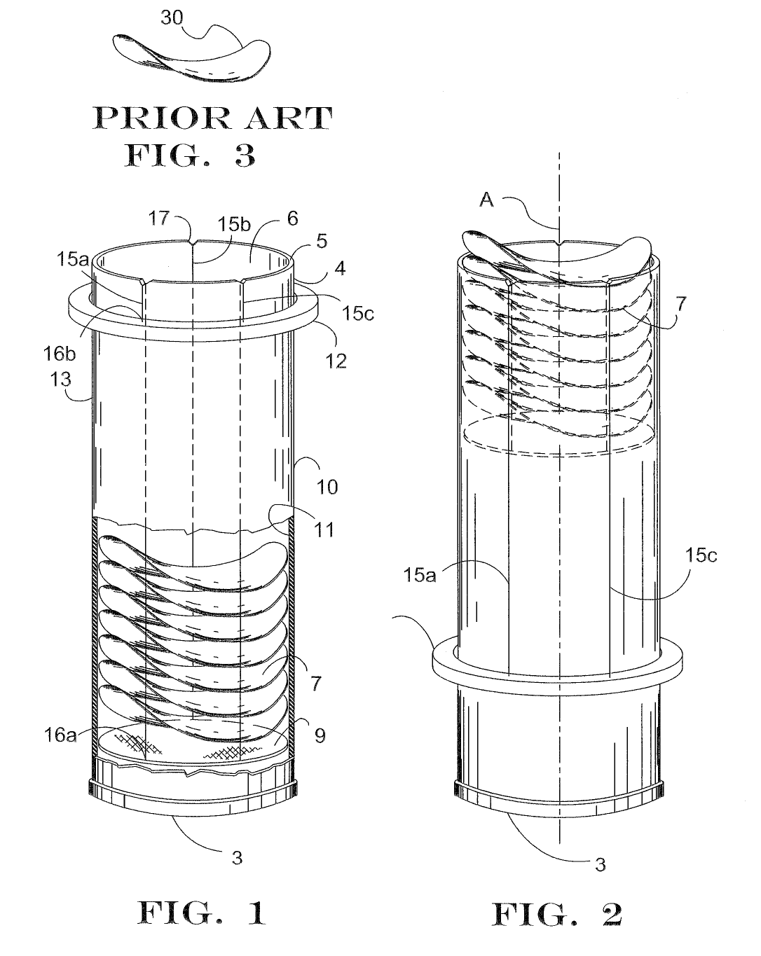

With reference to FIGS. 1 and 2, the novel chip dispensing container 10 is seen to have a case 2 with a tubular body. The body is elongated so as to define an axis of elongation A (FIG. 2). At one axial end of the body is a, base 3 and at the opposite axial end 4 the case has a rim 5 defining at the periphery an opening 6. Typically the base is a solid piece covering the axial end of the case. The hollow tubular body with the base thus form an open container suited to hold a stack of chips 7. Preferably the base is configured to permit the container to stand stably upright on a surface such as a table top

A representative individual chip 30 which may be packaged in the novel dispenser is illustrated in FIG. 3. For purposes of illustrating various features of the novel dispenser, only a partial stack of chips is shown in the figures. The opening 6 is broad enough to permit charging and discharging whole chips into and out of the interior of the container.

The novel chip dispensing container also includes a sling 9. The sling is shaped laterally, i.e., in directions perpendicular to the axis of elongation, to fit closely the inside cross section of the body but with a small clearance between the outer edge of the sling and the inner wall 11 shown in section view ill the lower position of FIG. 1. The clearance between sling and case permits the sling to slide in a direction parallel to the axis of elongation of the tubular body. The sling is intended to move in both directions, that is, up and down along the axis. On the outside of the case, the novel dispenser has a handle 12. The handle is operative to also move both up and down parallel to the axis of elongation. To this end, the inner surface of the handle facing the body has a clearance with the outer wall 13.

Spaced apart from each other along the rim 5 are multiple cables 15a-15c. The cables are flexible, substantially non-extendable, filamentary strands which each connect the sling 9 and the handle 12. More specifically, as seen with reference to cable 15a, each cable connects at an inside end 16a to the sling, extends upward inside the case in an axial direction to a position in proximity to rim 5 where it passes to the outside of the case, extends downward outside the case in an axial direction to an outside end 16b which connects to handle 12. The location of the case at which each of the cables passes from inside to outside of the body provides a bearing 17. Position of the bearing proximate to the rim causes the route of the cables between sling and handle to come close to the mouth of the opening of the container. The bearing also serves as a turning point for the cable such that the cable portion inside the container moves in one direction while the cable portion outside the container moves in the opposite direction. It can thus be appreciated that moving the handle 12 in one axial direction along the outside of the container causes the sling 9 to move in the opposite axial direction inside the container due to connection by the cables 15a-15c. That is, drawing the handle down causes the sling to rise and vice versa.

The utility of novel chip dispensing container is understood by comparison of FIGS. 1 and 2 in which the container is in preferred operating orientation with the axis oriented substantially vertically and opening facing up. FIG. 1 shows the container with about the lower half of the case cut away to reveal the sling 9 and a stack of chips 7 positioned near the base inside the container. The distance below the rim of these chips and the narrow dimension of the opening at the rim are such that it would be difficult if not impossible for the typical adult to reach even the top chip in the stack by reaching into the opening through the rim. The cables 15a-15c are of fixed length such that the handle 12 is suspended near the rim.

To make the chips accessible for manual removal without tilting and pouring, the handle 12 is drawn downward to a lower position shown in FIG. 2. In the figures, like parts have the same reference numbers. In FIG. 2, the lower portion of the case is shown restored to full view. As the handle is drawn downward, the fixed length cables hoist the sling upward along the direction of the axis. This elevates the stack of chips 7 in a smooth and continuous movement. The amount of distance that the sling raises is the same as that which the handle drops. In the illustration, the hoist is raised to a height effective to bring the top chip of the stack near and preferably slightly above the level of the rim 5. The user can then easily take the top chip from the stack. The lower chips in the stack remain positioned in the container and are protected from breaking and contamination. As the user consumes chips from the top of the stack, the handle 12 can be gradually lowered farther toward the base such that the next highest chips successively rise above the rim and can be manually withdrawn.

FIGS. 1 and 2, show a container holding a partial stack of chips for explanatory purposes. A fresh stock package when initially filled to capacity likely would contain an inventory of a whole stack of chips, i.e., a quantity of chips sufficient to fill the complete height of the container from near the base to near the rim. The bottom of the whole stack would rest upon the sling then positioned proximate to and possibly in directly in contact with the inside, upward facing surface of the base. If only a fraction of the total quantity of chips is taken from the stack, the handle can be raised to a high position, thereby lowering the sling and returning the unconsumed chips to a stable position at or near the bottom of the container.

In FIGS. 1 and 2, the bearing 17 for the cables is shown to be in the form of a notch indented in the upper surface of the rim 5. Notches can have any shape of indentation such as a V, U or semicircle. The notched bearing advantageously maintains the individual cables spread apart from each other along the rim. Preferably the cables will be spaced equidistantly apart from each other. If the cables gathered together, the sling could become unbalanced which could tend to tilt and spill the chips in the container or jam in the case preventing the stack to raise up or drop down.

Other variations of bearings are contemplated. For example, the bearing can take the form of a channel bored through the wall of the case near but below the rim. The cable can then be threaded through the channel like a thread passing through the eye of a needle rather than being draped over the rim.

At least three cables should be used to keep the sling in a level orientation, i.e., approximately perpendicular to the axis of elongation. The sling does not need to be precisely level and can have some tilt to its orientation provided that the chips do not slide off the sling or jam the sling. Preferably the novel chip dispensing container will utilize about 3-6 cables.

The purpose of the sling is to stably support the stack of chips while being raised and lowered within the container. Although a circular plate is illustrated in FIGS. 1 and 2, other variations are contemplated. For example the sling can be a perforated sheet. The lateral shape can be circular, elliptical, polygonal, such as triangular or rectangular for example. Other contemplated embodiments of the sling include substantially rigid beams assembled to form a rigid planar structure such as a cross, hub-and-spoke, spider web shape, and frame arrangement, to name a few representative examples. If the sling is designed adequately to keep the cables spread apart, discrete bearings such as notches and channels described above can be eliminated in which case a smooth, un-notched upper surface of the rim can serve the bearing function. Preferably the inside end of the cable is affixed near the radially outward extreme of the sling such that the cable rises close to the inside wall 11. This maximizes the volume available for storing the chips within the case between the array of cables. The cable can be affixed to the sling by any conventional method such as by piercing the sling with peripherally positioned bores, passing the cables through the bores and tying stop-knots in the cable protruding below the sling. Other attachment methods include adhering the inside end of the cable to the sling with a chemical adhesive or by thermal welding. Similar techniques can be used to afix the outside ends of the cables to the handle.

In another embodiment the individual cables can be brought together in a knot or thermally formed mass to make a sling formed by the network of converging cables that support the stack of chips. In this embodiment, a sling of a separate solid piece of material can be eliminated.

Conventional materials of construction can be used to fabricate the case, and base of the chip container. Such materials are disclosed in the Baur '798 patent for example. Typically the case will be composed of a fiberboard material that can be coated with a film or foil to provide moisture and vapor penetration resistance. The base call be metallic, for example aluminum and crimped over the bottom end of the tubular body to create a sanitary, vapor tight seal.

The handle, and sling are peferably composed of polymeric materials such as polyethylene or other inexpensive, easily processible materials. The fabrication techniques for making small polymeric articles such as injection molding of plastics are well known in the art.

The cables can be composed of stranded filamentary materials such as natural or synthetic fibers. Although multi-filament yarns may be used, preference is given for smooth, monofilament thread. For food service hygiene requirements, improved strength, shelf-life durability, and dimensional stability, synthetic monofilament of such compositions as polyethylene, polyamide, and polyester, for example, is preferred. Diameter of thee monofilament about that of modern fishing line is contemplated to be suitable for use in this invention.

The handle, cables and sling system should allow the stack of chips to move up and down in the case, preferably in a, smooth and continuous manner so that the stack can rise or fall to any desired elevation in immediate response to movement of the handle. In the embodiment illustrated in FIGS. 1 and 2, this controlled bidirectional movement is effected by cable tension. Tension on the cables is generated by the weight of product and the sling. The preferred utility for the novel chip-dispensing container is storage and dispensing of edible chips such as potato chips. Typically, the container will be 6-12 inches in height and will hold a single stack of chips. Thus with a whole stack of closely packed chips, the load on the sling should be about 4-8 oz. As the chips are consumed, the weight and tension diminishes accordingly. This tends to reduce the ability of the sling to automatically descend into the case as the handle is raised when the stack weight is low.

It is desirable to construct the novel container in such ways that promote tension in the cables so as to maintain the controlled bidirectional movement of the stack. Representative examples of construction techniques include the following. The bearing and cable surfaces should be suitably smooth and friction-free to avoid snagging the cable. Cables should be as pliant as practicable. Clearance between the lateral extremes of the sling and the inside wall of the body should as ample to avoid dragging resistance when the handle is released to allow the sling to fall downward. Consideration is given to making the sling heavy for example by making it of metal or by adding weight to the sling to provide adequate downward force when only a few chips remain.

Optionally, the sling can be encouraged to maintain a low position in the case with an elastic tension member. That is, one end of one or more elastic cords, bands or springs can be affixed to the underside of the sling and the opposite end affixed to the inside of the base. As the handle is drawn downward causing the sling to rise, tension is applied to the sling from below due to elastic stretching of the tension member. When the handle is released, the tension member contracts to draw the sling back downward toward the base of the container.

In one embodiment, the handle 12 slides axially without resistance along the outside of the case. Consequently, the sling can rise or fall smoothly, continuously and instantaneously in concert with user control of the handle. In an aspect of the invention the outer wall should have a substantially uniform profile in the axial direction that is preferably complementary to the inner surface of the handle. Also the clearance between the inner surface of the handle and the outer wall of the case should be effective to allow the hand to slide freely.

In another embodiment, the clearance between the handle and outer wall of the case provides slight resistance to axial movement. This enables the handle to be moved to a desired axial location, then be released by the user and remain in the desired axial location until the user subsequently re-adjusts the handle position. Various techniques are contemplated for having the handle hold axial position. For example, these include making the clearance between case outer wall and handle a compression fit distance, providing materials for the case wall and handle that exhibit a mutually high coefficient of friction, making the handle of a radially elastic composition such as rubber or foam, and giving the outer wall of the case a slightly conical shape such that the handle grips the outer wall with increasing force as it moves axially outside the case.

In one aspect, the novel chip dispensing container is contemplated to be used for original retail packaging of snack foods. In that utility, the container is intended for single-use and is disposable after the product initially supplied in the container is consumed. The cases of those containers typically are composed of inexpensive materials in view of their disposable purpose and relatively short service life. For example, the Pringles potato crisp product sold by Proctor and Gamble is apparently packaged in a cylinder of spiral wound fiberboard with a decorative coated paper outer wrapping. The label indicates that the canister contains at least 50% recyclable material and 15% post consumer content. Frito-Lay Inc. markets a potato crisp product under the trademark Stax™ which is packaged in a thin-walled, molded polymerci tubular container identified as being compatible with high density polyethylene and ethylene vinyl alcohol copolymer. For such single use, disposable utilities, the sling, cable and handle elements would be deployed on the package at the manufacturers production facility.

In another aspect, the novel chip dispensing container is contemplated to be distributed as a reusable, serving utensil independent of the chip product. That is, the consumer can purchase a chip dispensing container according to this invention and use it to serve stacks of chips originally supplied in the manufacturer's packaging and transferred into the consumer's container. Such a reusable chip dispensing container (“RCD container”) has the advantage of elevating the style of chip dispenser from a supermarket shelf package to a decorative, aesthetically appealing serving device that is suitable for serving to guests at a dinner table. The RCD container also provides appeal as an entertaining novelty item. Still further, the RCD container can be used to serve other discrete, stackable items such as cookies, thin mint chocolate candies and the like. Appropriately styled and constructed reusable containers according to this invention might also find use for distributing thin friable wafers in certain religious ceremonies. While primarily directed to dispensing stacks of edible articles, the RCD container can be adapted for use to dispense non-editable items such as compact disks, dinner plates, coasters and the like. It should be understood that any stackable product which can be stored and dispensed with a reusable chip dispensing container can also be packaged by the product manufacturer in a single use chip dispensing container.

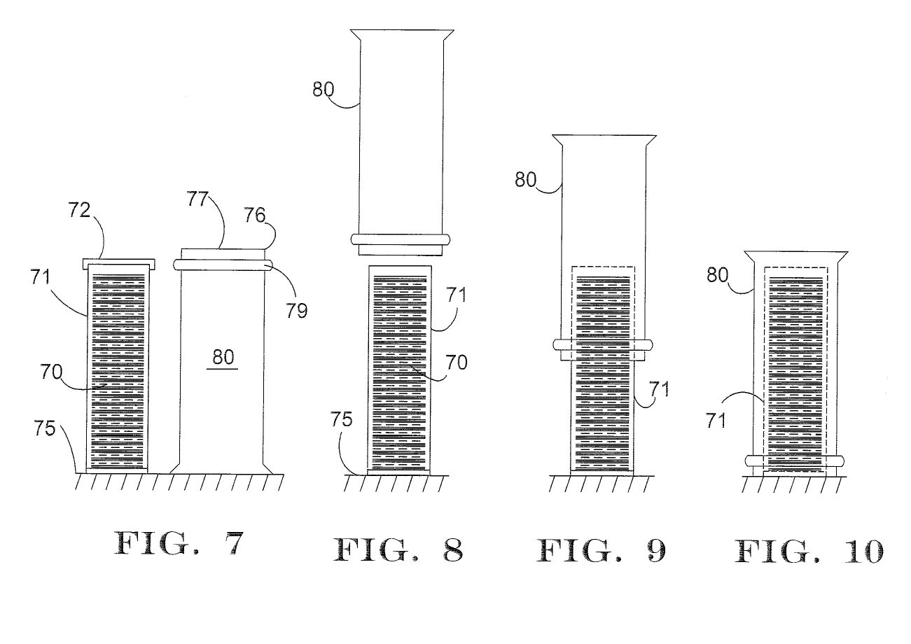

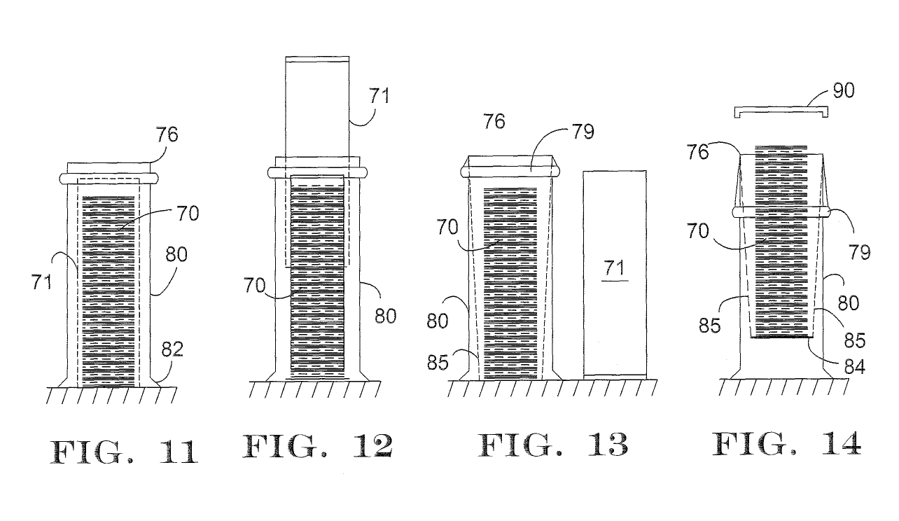

Operation of the RCD container can be understood with reference to FIGS. 7-13 and the following further description. The consumer obtains a supply of stackable chips 70. Preferably the chips are obtained pre-packaged in an original manufacturer's package 71, such as a Pringles potato crisps cannister or a Stax brand potato crisps tube. The consumer removes the cover 72 to open the supply package and places the package 71 in vertical orientation preferably on a stable surface 75 such as a table top with the package opening facing up. The novel RCD container 80 is shown in FIG. 7 in its normal upright orientation with external handle 79 and with rim 76 and opening 77 facing upward. In FIG. 8 the RCD container 80 is shown inverted such that the opening faces down. The inverted RCD container is positioned above the opened package 71 and moved downward to envelope the commercial product package having the stack of chips 70 inside. FIG. 9 illustrates the inverted RCD container in a lower position and enveloping the upper portion of package 71. In FIG. 10 the novel RCD container 80 is completed lowered and fully envelopes package 71. When the product package 71 is almost entirely or completely inside the inverted RCD container 80, the chip-filled package and the RCD container together in combination are gently turned upside-down such that the RCD container bottom 82 (FIG. 11) is down and the RCD container rim 76 is up as shown in FIG. 11. While turning the package-within-RCD container combination, the user should take care to prevent the package 71 from falling downward out of the opening 77. The stack of chips 70 resettles onto the sling 84 (FIG. 14) at the base of the RCD container. The package 71 for the stack of chips can then be lifted out of the opening 76 of the RCD container as shown partially completed in FIG. 12. This leaves the original package 71 empty and the stack 70 of chips stacked neatly within the RCD container 80, FIG. 13. FIG. 13 also shows cables 85 extending from the sling 84 under the stack 71 to the rim and from the rim to the handle 79. The cables are not shown in FIGS. 7-12 for simplicity. The stack is and ready for dispensing as explained above. FIG. 14 shows the RCD container with the handle 79 drawn downward which hoists the sling 84 and raises the stack 70 such that the top of the stack rises to or slightly above the rim 76 for easy access by the user. An optional cap 90 can be provided to cover the RCD container when only a part of the stack is consumed by the user.

FIGS. 7-14 illustrate the RCD container and/or product package in contact with surface 75 for the purpose of clarifying the orientation of the articles. It is not critical that the package and RCD container be in contact at all times. The transfer of the stack of chip product can take place while holding both articles in hand. Inverting the articles can be performed manually.

The RCD container will have the features of the disposable novel container disclosed above. In addition, the inner radial dimension of the reusable chip dispensing container should be slightly larger than the outer dimension of commercially available chip product packages. Also, the inside height of the novel RCD container should be about the same as the height of the commercial packages. Both of the Pringles and Stax brands of chip product mentioned above are presently made available to consumers in tubular canisters that measure about 3 inches outer diameter and about 9 inches high. To accommodate these packages, an RCD container according to this invention should have an inner cross section dimension of about 3.2-3.4 inches and a height of about 8.5-9 inches. It is noted that the Stax brand package has a circular cross section of about 3 inches at its top and bottom regions and which necks down to all oval cross section having a major axis of about 3 inches and a minor axis of about 2.25 inches for most of its height between the bottom and top regions. Despite the non-cylindrical shape of the Stax product package, it should work with the RCD container to transfer the packaged chips as a stack.

When the RCD container is inverted to insert the stack of chips, the handle and the sling will tend to move axially toward the rim. Preferably the RCD container also will have additional elements to prevent the handle and sling from falling away from the inverted container. For example, short radially directed protrusions can extend inward from the inner wall of the case at the rim to stop the sling from falling out of the opening. Alternatively, a tension member connecting the sling to the inside of the base as described above can prevent expulsion of the sling. Similarly the rim can be provided with a small outwardly projecting flange to prevent the handle from slipping off the case when inverted. Also it is recommended that channel embodiment (that is, holes bored through the side of the case body, as above) of cable bearings be utilized for the RCD container. The cables passing through the eyes of the channels will thus be retained in lateral position near the rim when the RCD container is inverted.

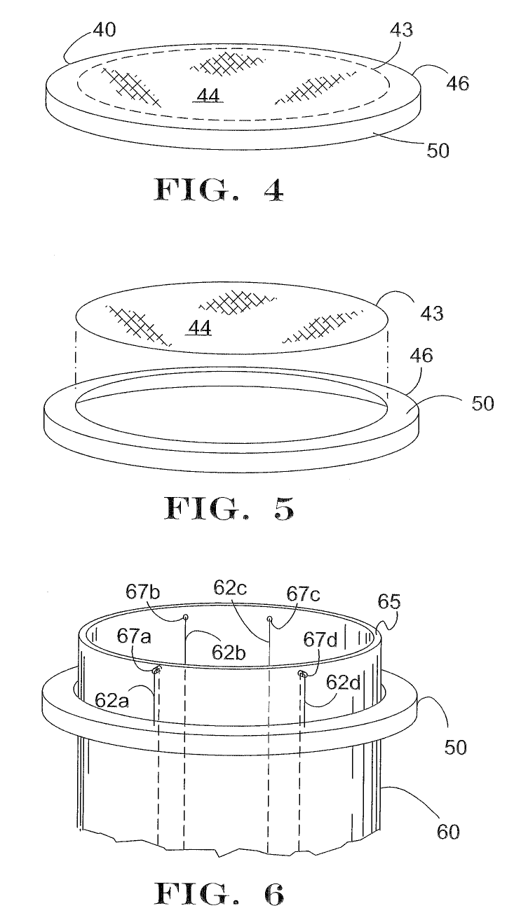

To simplify the incorporation of the present invention into the design of existing conventional commercial tube-stacked chip product packages and to potentially reduce the cost of implementing this invention, a technique for making the handle from existing parts is disclosed as follows. Pringles and Stax tube-stacked chip product containers both are provided with two covers. One is a foil or film membrane adhesively sealed to the rim of the tubular containers. Over this membrane is a rigid, circular polymeric cap. The cap has a shape similar to that shown in FIG. 4. The cap can be non-destructively removed to provide access to the membrane. The membrane is a tamper-evident and vapor tight cover. Removing the membrane irreversibly destroys the seal and indicates to the consumer that the package has been opened. The polymeric cap can be replaced by the consumer to provide a removable vapor resistant cover on the unsealed container. Thus the consumer can remove some product chips from the package, and replace the polymeric cap to retain product freshness for at least a short period. The polymeric cap also importantly provides a strong physical barrier against accidental penetration of the thin foil or film membrane. Hence the polymeric cap is provided in any event to protect the membrane even if the consumer does not intend to re-close the container after removing some but not all of the chips.

The technique of adapting the polymeric cap to form the handle of the novel container can be understood with reference to FIGS. 4-6. FIG. 6 shows a portion of the novel container 60 near the rim 65. It is observed that in this illustrated embodiment four cables 62a-62d are deployed. Also, bores 67a-67d through the wall of the case body serve as bearings for the cables. FIG. 6 further shows a modified polymeric cap 40 suitable for easy fabrication of a handle 50. Cap 40 has a central, disk-shaped panel 44 and a ring 46 surrounding the panel. In a conventional polymeric cap for existing tube-stacked chip product packages, the panel and ring are integrated as a single piece. FIGS. 4 and 5 are intended to show that by simply scoring or perforating cap 40 at line 43, the panel 44 can be readily separated from ring 46 with manual force. The ring thus becomes handle 50 shown in FIG. 6 as being lowered into position slightly below rim 65 and attached to ends of cables 62a-62d.

The novel chip dispensing container can be used to package, store and dispense a variety of stackable articles including chips, crisps, candies, cookies and wafers. The container also can be adapted for use to dispense non-editable items such as compact disks, dinner plates, coasters and the like. It should be understood that any stackable product which can be stored and dispensed with a reusable chip dispensing container can also be packaged by the product manufacturer in a single use chip dispensing container. Furthermore, although this disclosure has emphasized a chip dispensing container having a cylindrical case, it is contemplated that tubular cases having other shaped profiles such as those with straight sides, i.e., triangular, rectangular and higher order polygonal profiles or irregular shapes call be used with this invention.

Although specific forms of the invention have been selected in the preceding disclosure for illustration in specific terms for the purpose of describing these forms of the invention fully and amply for one of average skill in the pertinent art, it should be understood that various substitutions and modifications which bring about substantially equivalent or superior results and/or performance are deemed to be within the scope and spirit of the following claims.

What is claimed is:

1. A chip dispensing container for a stack of articles comprising
(a) a case having a tubular body defining an axis, an external body profile, and a rim at one axial end of the case defining the periphery of an opening of size effective to receive the stack,
(b) a sling inside the case adapted to move along the axis,
(c) a handle circumscribing the body profile and adapted to slide along the axis outside of the case,
(d) a plurality of cables oriented parallel to the axis and positioned apart from each other along the opening, and
(e) a bearing for each cable positioned proximate to the rim,
in which each cable is affixed at one cable end to the sling, extends axially inside the case from the sling to a bearing, contacts the bearing, extends axially outside the case from the bearing to the handle, and is affixed at the other cable end to the handle.

2. The chip dispensing container of claim 1 in which the axial end of the body opposite the opening is closed.

3. The chip dispensing container of claim 1 in which the axial end of the body opposite the opening defines a base shaped to stably support the case on a flat horizontal surface such that the opening faces up.

4. The chip dispensing container of claim 3 in which the case is a cylindrical tube having a substantially flat circular panel closing the axial end of the body opposite the opening.

5. The chip dispensing container of claim 4 in which the handle is a circular ring.

6. The chip dispensing container of claim 3 which further comprises a removable cover closing the opening.

7. The chip dispensing container of claim 6 in which the cover comprises a rigid frame circumscribing the case and a detachable panel within the frame such that detachment of the panel exposes the rim and forms the handle from the frame.

8. The chip dispensing container of claim 1 in which the sling is a support structure selected from the group consisting of a sheet, a frame, a webbed frame and a junction of a plurality of the cables.

9. The chip dispensing container of claim 1 in which the rim is the bearing for the cables.

10. The chip dispensing container of claim 9 in which the bearings are defined by notches in the rim.

11. The chip dispensing container of claim 1 in which the bearings are defined by perforations through the body of the case such that each cable passes through a perforation.

12. The chip dispensing container of claim 1 in which the cables are monofilament fibers.

13. A method of packaging chip-shaped articles comprising the steps of
(I) providing a stack of a plurality of substantially identically chip-shaped articles,
(II) providing a chip dispensing container comprising (a) a case having a tubular body defining an axis, an external body profile, and a rim at one axial end of the case defining the periphery of an opening of size effective to receive the stack, (b) a sling inside the case adapted move along the axis, (c) a handle circumscribing the body profile and adapted to slide along the axis outside of the case, (d) a plurality of cables oriented parallel to the axis and positioned apart from each other along the opening, and (e) a bearing for each cable positioned proximate to the rim, in which each cable is affixed at one cable end to the sling, extends axially inside the case from the sling to a bearing, contacts the bearing, extends axially outside the case from the bearing to the handle, and is affixed at the other cable end to the handle, and
(III) placing the stack into the container such that the chip-shaped articles remain in a stacked conformation with one article at a foot of the stack being in contact with the sling, another article at a head of the stack being proximate to the rim and the stack aligned parallel to the axis.

14. The method of claim 13 further comprising the step of deploying a cover on the rim, thereby enclosing the stack within the case.

15. The method of claim 14 in which the articles are discrete, unwrapped, edible, ready-to-eat pieces of food and the step of deploying a cover comprises completely covering over the opening with a bacterial barrier cover and sealing said cover to the rim, thereby protecting the articles from external bacteria contamination.

16. The method of claim 14 in which the cover comprises a rigid frame circumscribing the case and a detachable panel within the frame such that detaching the panel exposes the rim of the case and forms the handle from the frame.

17. A method of dispensing chip-shaped articles comprising the steps of
(I) providing a chip dispensing container containing a stack of a plurality of substantially identically chip-shaped articles,
in which the container comprises (a) a case having a tubular body defining an axis, an external body profile, and a rim at one axial end of the case defining the periphery of an opening of size effective to receive the stack, (b) a, sling inside the case adapted move along the axis, (c) a handle circumscribing the body profile and adapted to slide along the axis outside of the case, (d) a plurality of cables oriented parallel to the axis and positioned apart from each other along the opening, and (e) a bearing for each cable positioned proximate to the rim, in which each cable is affixed at one cable end to the sling, extends axially inside the case from the sling to a bearing, contacts the bearing, extends axially outside the case from the bearing to the handle, and is affixed at the other cable end to the handle, and
in which the stack is positioned in the container such that the chip-shaped articles remain in a stacked conformation with one article at a foot of the stack being in contact with the sling, another article at a head of the stack being proximate to the rim and the stack aligned parallel to the axis,
(II) maintaining the container in vertical orientation such that the opening faces upward,
(III) moving the handle downward to elevate the stack effectively to expose an article at the head of the stack above the rim, and
(IV) removing the article at the head of the stack.

18. The method of claim 17 in which the step of providing a chip dispensing container further comprises (1) providing an opened commercial consumer package of chip-shaped articles conformed in a stack within the package, (2) with the package oriented substantially vertically such that the stack is facing up and the chip dispensing container positioned above the package and in an inverted vertical orientation such that the opening faces downward, inserting the package into the chip dispensing container, (3) inverting the chip dispensing container to a vertical orientation such that the opening faces upward, and (4) removing the package from the chip dispensing container and leaving the stack of articles inside the chip dispensing container.
